(19) United States
(12) Patent Application Publication
(10) Pub. No.: US 2019/0233244 A1
(43) Pub. Date: Aug. 1, 2019

(54) CONTINUOUS MANUFACTURING APPARATUS AND METHOD FOR OPTICAL DISPLAY UNIT

(71) Applicants: NITTO DENKO CORPORATION, Ibaraki-shi, Osaka (JP); YODOGAWA MEDEC CO., LTD., Suita-shi, Oska (JP); YODOGAWA HU-TECH CO., LTD., Suita-shi, Oska (JP)

(72) Inventors: Kazuo KITADA, Ibaraki-shi, Osaka (JP); Hirofumi SAIGOU, Ibaraki-shi, Osaka (JP); Satoru TAKEDA, Ibaraki-shi, Osaka (JP); Tomokazu YURA, Osaka-shi, Osaka (JP); Takehiko KATADA, Osaka-shi, Osaka (JP); Katsumi EGUCHI, Osaka-shi, Osaka (JP)

(21) Appl. No.: 16/331,104

(22) PCT Filed: Jul. 14, 2017
(86) PCT No.: PCT/JP2017/025759

§ 371 Date: Mar. 6, 2019

(30) Foreign Application Priority Data
Sep. 6, 2016 (JP) 2016-173338

(51) Int. Cl. B65H 37/04; B65H 41/00; G09F 9/30; G02F 1/1335; B32B 38/18

(52) U.S. Cl. CPC B65H 37/04; B65H 41/00; B32B 38/1816; G02F 1/133514; G09F 9/30

(57) ABSTRACT

A continuous manufacturing apparatus for an optical display unit which allows for laminating a sheet of optical functional film with a panel member, even when length of each of their long sides is wide, without lowering lamination accuracy and/or increasing generation of bubbles by lamination. In a RTP system using laminating rollers having sufficient length not being bent by their own weight, when using a sheet of optical functional film which each of long sides is longer than the length of the laminating rollers, each of the sheets of optical functional film is conveyed on a band of carrier film in a continuously aligned state such that each of short sides extend in a direction crossing a conveying direction, and peeled from the band of carrier film at a laminating part to be laminated with one of opposite surfaces of the panel member.

### CROSS REFERENCE TO RELATED APPLICATION

This application claims the priority of Japanese Patent Application No. 2016-173338, filed on Sep. 6, 2016, in the JPO (Japanese Patent Office). Further, this application is the U.S. National Phase Application of International Application No. PCT/JP2017/025759, filed on Jul. 14, 2017, which designates the United States and was published in Japan. Both of the priority documents are hereby incorporated by reference in their entireties.

### TECHNICAL FIELD

The present invention relates to a continuous manufacturing apparatus and method for an optical display unit. More specifically, the present invention relates to a manufacturing apparatus and method which allows for laminating a sheet of optical functional film with a panel member even when manufacturing a large optical display unit of a certain size or more, without lowering lamination accuracy and/or increasing entrapment frequency of bubbles due to bending of laminating rollers.

### BACKGROUND ART

In recent years, in a manufacturing site of optical display units, a manufacturing apparatus and method of Roll-to-Panel (RTP) are employed (for example, Patent Literature 1). In the RTP method, generally, an optical display unit is continuously manufactured as follows. First, a band of optical film laminate having a predetermined width is fed from a roll. The band of optical film laminate is configured as including a band of carrier film, a pressure-sensitive adhesive layer laminated on one of opposite surfaces of the carrier film, and an optical film laminated on the band of carrier film via the pressure-sensitive adhesive layer. The optical functional film may be a single-layered or multi-layered film. On the fed band of optical film laminate, slit lines are continuously formed in a width-wise direction to form sheets of optical functional film between adjacent slit lines.

The sheets of optical functional film continuously supported on the band of carrier film are respectively peeled with the pressure-sensitive adhesive layer from the band of carrier film by a peeling means arranged near a laminating position, and sent to the laminating position. Each of the sheets of optical functional film reached to the laminating position is laminated with a face to be laminated of a corresponding panel member separately conveyed to the laminating position by a laminating means provided at the laminating position. The panel member, which one of opposite surfaces is laminated with the sheet of optical functional film, is generally laminated with another sheet of optical functional film on the other of opposite surfaces. When laminated with the other of opposite surfaces, another sheet of optical functional film peeled from the band of carrier film with the pressure-sensitive adhesive layer by another peeling means is sent to a laminating position same as or different to the position, where the first sheet of optical functional film and the panel member were laminated, to be laminated with the other of one of opposite surfaces of the panel member.

The laminating means used in the RTP system has an upper side laminating roller and a lower side laminating roller which each of rotating axes generally extends in a direction perpendicular to a conveying direction of the sheet of optical functional film and the panel member. The upper and lower laminating rollers apply pressure in opposing directions with each other from a direction perpendicular to surfaces of the sheet of optical functional film and the panel member at the laminating position, with inversely rotating with each other, to laminate the sheet of optical functional film with the panel member from its front end to its rear end. Length of the laminating rollers in a direction parallel to the rotating axes must be longer than width of the sheet of optical functional film and the panel member to be laminated. The sheet of optical functional film and the panel member are conveyed to the laminating position with their deviation of relative positions preliminarily corrected, that is, with their positions preliminarily aligned.

By the way, in recent years, optical display units are growing in size, and size of the sheets of optical functional film and/or the panel members used therefor are correspondingly growing in size. For example, a panel member which diagonal dimension is 70 inches used for a liquid crystal display unit for a large television has short sides of about 870 mm to 875 mm, long sides of about 1545 mm to 1555 mm, and a polarizing film to be laminated with the panel member is also about such size. Laminating rollers included in the RTP system for laminating the polarizing film and the panel member of such wide width must be at least longer than the width of the long side of the panel member, and thus, for the RTP system for manufacturing an optical display unit having a size, for example, of 70 inches, rollers having laminating surfaces of a length of about 1600 mm are used.

On the other hand, in recent optical display units, improvement in the lamination accuracy of the panel member and the sheet of optical functional film is required, and this is similarly applied for the large optical display units. In the RTP system, as one means for improving the lamination accuracy, a distance from the front end of the peeling means for peeling the sheet of optical functional film from the band of carrier film to the laminating position is set as short as possible, and generally, this distance is often designed as from about 30 mm to about 50 mm. A distance from the front end of the peeling means to the laminating position is so short as described in the above and space around the laminating position is extremely limited, and thus, each of diameters of the laminating rollers must be made small. For example, each of the diameters of the laminating rollers used in the large RTP system is about 30 mm to 80 mm.

Thus, in the RTP system which allows for continuously manufacturing the large optical display units, the pair of upper and lower long laminating rollers which each of diameters is small are used to laminate the optical functional film with the panel member of wide width. However, for the laminating rollers with small diameters, the longer the length they have, the more central parts bend by their own weight. When the sheet of optical functional film and the panel member are sandwiched using the upper laminating roller and the lower laminating roller with the bent central parts, the sheet of optical functional film and the panel member cannot be pressurized uniformly with respective laminating surfaces of the laminating rollers, and problems such as lowering of the lamination accuracy and/or increase of entrapment frequency of bubbles into the laminating surfaces are caused.

Patent Literature 2 proposes a technique intended to deal with a lamination problem due to such bending of laminating rollers. In the technique proposed in Patent Literature 2, on a presumption that long laminating rollers of small diameters bend by their own weight, a lower backup roller abutting a lower roller is provided downward thereof for preventing such bending, and an upper backup roller abutting an upper roller is provided upward thereof for preventing such bending.

Patent Literature 3 proposes a polarizing plate laminating apparatus which allows for simultaneously laminating each of polarizing plates on respective surfaces of a transparent substrate, and also, it avoids half-cutting. This apparatus is configured by connecting a plurality of polarizing plate units, each of which is formed by laminating a separator to a polarizing plate, to make a long band body, and then, peeling the polarizing plate from each of the separators of respective band bodies to be laminated with respective surfaces of the transparent substrates.

### CITATION LIST

Patent Literature 1: Japanese Patent 4377964B

Patent Literature 2: Japanese Laid-Open Patent Publication JP2011-227336A

Patent Literature 3: Japanese Laid-Open Patent Publication JP2011-257463A

Patent Literature 4: Japanese Laid-Open Patent Publication JP2004-250153A

### SUMMARY OF INVENTION

### Technical Problem

Even if the lower laminating roller and the upper laminating roller are respectively provided with the corresponding backup roller abutting thereto, as proposed in Patent Literature 2, the backup rollers themselves arranged in a narrow space also must be long rollers of small diameters similar to the laminating rollers, and bending of the backup rollers cannot be avoided, and thus, eventually, it is difficult to completely prevent the bending of the laminating rollers. In addition, in the laminating position where only the limited narrow space exists, it is extremely difficult in reality to adopt the configuration in which the backup rollers are further arranged upward and downward of the pair of laminating rollers. Further, the upper and lower laminating rollers are configured to repeat actions of moving close and apart from each other, and the backup rollers must be moved corresponding to such actions, and thus, a mechanism and control of the laminating part becomes complexed.

In the technique proposed in Patent Literature 3, the sheet of polarizing film must be prepared even when the sheet of polarizing film is not necessary to be used. With this technique, advantages of the RTP method (advantages of film handling resulting from unnecessity for preparing the sheet of polarizing film) adopted for solving problems in a conventional type, which has generally been adopted before the RTP method, that is, problems of conveyance and/or management of the sheet of polarizing film become difficult, and/or entrapment of foreign substances may be caused at times of packing and unpacking, may largely be reduced. Therefore, the configuration in which the sheet of optical functional films are coupled to make a band-like configuration is desirable to be adopted only in a very limited case where the above problems (the problems such as lowering of the lamination accuracy and/or increase of the entrapment frequency of bubbles into the laminating surfaces) which may be caused when the RTP method is used can be solved, that is, a case where the sheet of optical functional film larger than a predetermined size needs to be laminated with the panel member.

The present invention aims to provide a continuous manufacturing apparatus and method for an optical display unit which allows for laminating a sheet of optical functional film with a panel member, even when length of each of their long sides is longer than the length of laminating rollers, without lowering lamination accuracy and/or increasing generation of bubbles by lamination, using the laminating rollers having sufficient length not being bent by their own weight.

### Solution to Problem

The above problem can be solved by, in a RTP system using laminating rollers having sufficient length not being bent by its own weight, when using a sheet of optical functional film which each of long sides is longer than the length of the laminating rollers, conveying each of the sheets of optical functional film on a band of carrier film in a continuously aligned state such that each of short sides extends in a direction crossing a conveying direction, and peeling from the band of carrier film at a laminating part to be laminated with one of opposite surfaces of the panel member. The band of optical film laminate in which each of the sheets of optical functional films is aligned on the band of carrier film can be formed by coupling short sides of a sheet of releasing film of a laminate in which the sheet of releasing film and the sheet of optical functional film are laminated. The band of optical film laminate can also be formed by laminating a sheet of optical functional film on the band of carrier film. The band of optical film laminate can also be formed by laminating the laminate in which the sheet of releasing film and the sheet of optical functional film are laminated on the band of carrier film.

Further, in the present specification, the laminating rollers having sufficient length not being bent by their own weight include not only laminating rollers having the length not being bent by their own weight at all, but also laminating rollers having the length which allows to be bent which may cause generation of bubbles by lamination and/or lowering of lamination accuracy to an extent not affecting a quality of an end product when the panel member and the sheet of optical functional film are laminated by pressure applied by the laminating rollers.

The present invention provides, in one aspect, a continuous manufacturing apparatus for an optical display unit. The apparatus includes an optical functional film feeding part and an optical film laminate forming part. The optical film feeding part feeds rectangular first sheets of optical functional film. The optical film laminate forming part forms a first band of optical film laminate in which each of the first sheets of optical functional film is continuously aligned in a conveying direction such that each of short sides extends in a direction crossing the conveying direction on a first band of carrier film. In one embodiment, each of the first sheets of optical functional film fed from the optical functional film feeding part is laminated on each of sheets of releasing film, and the optical film laminate forming part may include a coupling means for coupling opposing short sides of the sheets of releasing film to make the first band of carrier film.

The apparatus further includes a first optical film laminate conveying part, a second optical film laminate conveying part, and a panel member conveying part. The first optical film laminate conveying part conveys the first band of optical film laminate toward a first laminating part. The second optical film laminate conveying part conveys a second band of optical film laminate including a second band of carrier film and rectangular second sheets of optical functional film continuously supported on the second band of carrier film such that each of short sides extends in a direction crossing the conveying direction toward a second laminating part. The panel member conveying part conveys the panel member toward the first and the second laminating parts.

The first laminating part includes a first peeling means for peeling the first sheet of optical functional film from the first band of carrier film, and a first laminating means for laminating the peeled first sheet of optical functional film with one of opposite surfaces of the panel member. The first laminating means has a length in a width direction of the first sheet of optical functional film, and the length is longer than the short side of the first sheet of optical functional film. The second laminating part includes a second peeling means for peeling the second sheet of optical functional film from the second band of carrier film, and a second laminating means for laminating the peeled second sheet of optical functional film with the other of opposite surfaces of the panel member.

In another embodiment, the apparatus may further include a carrier film feeding part for feeding the first band of carrier film. In this embodiment, the optical film laminate forming part is configured to laminate the first sheet of optical functional film fed from the optical functional film feeding part on the first band of carrier film fed from the carrier film feeding part.

In a further embodiment, the apparatus further includes a carrier film feeding part for feeding the first band of carrier film, and each of the first sheet of optical functional film fed from the optical functional film feeding part may preferably be laminated on each of sheets of releasing film. In this embodiment, the optical film laminate forming part is configured to laminate the first sheet of optical functional film with the sheet of releasing film fed from the optical functional film feeding part on the first band of carrier film fed from the carrier film feeding part such that the sheet of releasing film contacts the first band of carrier film.

In a further embodiment, the apparatus further includes a carrier film feeding part for feeding the first band of carrier film, and each of the first sheet of optical functional film fed from the optical functional film feeding part may preferably be laminated on each of sheets of releasing film. In this embodiment, the optical film laminate forming part includes a peeling means for peeling the sheet of releasing film from the first sheet of optical functional film with the sheet of releasing film fed from the optical functional film feeding part. The optical film laminate forming part is configured to laminate the first sheet of optical functional film after the sheet of releasing film is peeled on the first band of carrier film fed from the carrier film feeding part.

The apparatus may further include a third optical film laminate conveying part. The third optical film laminate conveying part conveys a third band of optical film laminate including a third band of carrier film and rectangular third sheets of optical functional film toward the first laminating part. The third sheet of optical functional film has long sides shorter than the length of the first laminating means, and the third band of optical film laminate is a laminate in which each of the third sheets of optical functional film is continuously supported on the third band of carrier film such that each of long sides extends in a direction crossing the conveying direction. When laminating the third sheet of optical functional film with one of opposite surfaces of the panel member, the apparatus preferably further includes a rotating part for rotating an intermediate laminate laminated as such, or an intermediate laminate before the third sheet of optical functional film is laminated with one of opposite surfaces of the panel member, by 90 degrees.

The present invention provides, in another aspect, a continuous manufacturing method for an optical display unit. The method comprises a step of feeding a rectangular first sheet of optical functional film, and a step of forming a first band of optical film laminate in which each of the first sheets of optical functional films is continuously aligned in a conveying direction such that each of short sides extends in a direction crossing the conveying direction on a first band of carrier film. In one embodiment, each of the first sheets of optical functional film fed in the step of feeding the first sheet of optical functional film is laminated on each of sheets of releasing film, and the step of forming the first band of optical film laminate may include a step of coupling opposing short sides of the sheets of releasing film to make the first band of carrier film.

The method further includes a step of conveying the first band of optical film laminate toward the first laminating position, a step of conveying the second band of optical film laminate toward the second laminating position, and a step of conveying the panel member toward the first and second laminating positions. The second band of optical film laminate includes a second band of carrier film and rectangular second sheets of optical functional film continuously supported on the second band of carrier film such that each of short sides extends in a direction crossing the conveying direction.

The method further includes a step of peeling the first sheet of optical functional film from the first band of carrier film, a step of laminating the peeled first sheet of optical functional film with one of opposite surfaces of the panel member using a first laminating means, and a step of peeling the second sheet of optical functional film from the second band of carrier film and laminating the peeled second sheet of optical functional film with the other of opposite surfaces of the panel member using a second laminating means. The first laminating means has a length in a width direction of the first sheet of optical functional film, which is longer than the short side of the first sheet of optical functional film.

In another embodiment, the method may further include a step of feeding the first band of carrier film. In this embodiment, the step for forming the first band of optical film laminate includes a step of laminating the first sheet of optical functional film fed in the step of feeding the first sheet of optical functional film on the first band of carrier film fed in the step of feeding the first band of carrier film.

In a further embodiment, the method further includes a step of feeding the first band of carrier film, and each of the first sheets of optical functional film fed in the step of feeding the first sheet of optical functional film may be laminated on each of sheets of releasing film. In this embodiment, the step of forming the first band of optical film laminate includes a step of laminating the first sheet of optical functional film fed in the step of feeding the first sheet of optical functional film on the first band of carrier film with the sheet of releasing film fed in the step of feeding the first band of carrier film such that the sheet of releasing film contacts the first band of carrier film.

In a further embodiment, the method further includes a step of feeding the first band of carrier film, and each of the first sheets of optical functional film fed in the step of feeding the first sheet of optical functional film may be laminated on each of sheets of releasing film. The step of forming the first band of optical film laminate includes a step of peeling the sheet of releasing film from the first sheet of optical functional film with the sheet of releasing film fed in the step of feeding the first sheet of optical functional film, and a step of laminating the first sheet of optical functional film after the sheet of releasing film is peeled on the first band of carrier film fed in the step of feeding the first band of carrier film.

### BRIEF DESCRIPTION OF DRAWINGS

FIG. 1 is a schematic diagram for illustrating idea of using a band of optical film laminate in the present invention.

FIG. 2 is a schematic top view showing a configuration of a continuous manufacturing apparatus of an optical display unit according to one embodiment of the present invention.

FIG. 3(a), FIG. 3(b) and FIG. 3(c) are schematic side views showing a configuration of a continuous manufacturing apparatus of an optical display unit according to one embodiment of the present invention, and view of a line provided with a first laminating part, seen from a lower side of FIG. 2.

FIG. 4(a) and FIG. 4(b) are schematic side views showing a configuration of a continuous manufacturing apparatus of an optical display unit according to one embodiment of the present invention, and a view of a line provided with a second laminating part, seen from a lower side of FIG. 2.

FIG. 5(a) and FIG. 5(b) are schematic side views showing a part of a continuous manufacturing apparatus of an optical display unit according to another embodiment of the present invention.

FIG. 6(a) and FIG. 6(b) are schematic side views showing a part of a continuous manufacturing apparatus of an optical display unit according to a further embodiment of the present invention.

FIG. 7(a) and FIG. 7(b) are schematic side views showing a part of a continuous manufacturing apparatus of an optical display unit according to another embodiment of the present invention.

### DESCRIPTION OF EMBODIMENTS

In the following, a continuous manufacturing apparatus and a continuous manufacturing method of the optical display unit according to the present invention are described in detail with references to drawings.

### Summary of Present Invention

The present invention relates to a RTP system including a pair of laminating rollers having sufficient length not being bent by their own weight. The length of each of the laminating rollers is the length in a direction parallel to a rotating axis of the laminating rollers. In the present invention, when using a rectangular sheet of optical functional film which each of long sides is longer than the length of the laminating rollers, each of the sheets of optical functional film is conveyed on a band of carrier film in a continuously aligned state toward a laminating part such that each of short sides extends in a direction crossing a conveying direction, and peeled from the band of carrier film at a laminating part to be laminated with one of opposite surfaces of the panel member separately conveyed to the laminating part. In one embodiment, the band of optical film laminate in which each of the sheets of optical functional film is conveyed on a band of carrier film in a continuously aligned state such that each of short sides extend in a direction crossing a conveying direction can be formed by coupling short sides of a sheet of releasing film of a laminate in which the sheet of releasing film and the sheet of optical functional film are laminated. In another embodiment, the band of optical film laminate can be formed by laminating a sheet of optical functional film on the band of carrier film. In further embodiment, the band of optical film laminate can be formed by laminating the laminate in which the sheet of releasing film and the sheet of optical functional film are laminated on the band of carrier film.

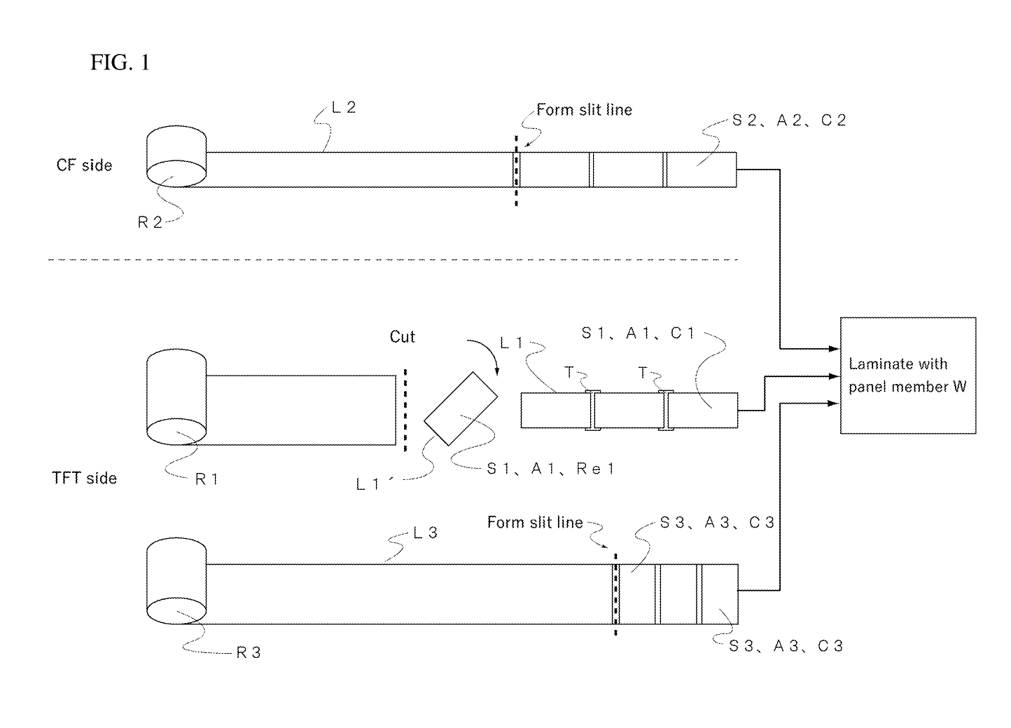

FIG. 1 is a figure for illustrating idea of using the band of optical film laminate according to the present invention. In the present invention, a liquid crystal display unit P2 can be made by laminating a first sheet of optical functional film S1 (for example, a polarizing film) with a surface of a thin film transistor side (TFT side) of a panel member W, and laminating a second sheet of optical functional film S2 (for example, a polarizing film) with a surface of a color filter side (CF side) of the panel member W.

As shown in FIG. 1, the first sheet of optical functional film S1 is used when a size of the panel member W is larger than a certain size. The first sheet of optical functional film S1 has short sides each of which is shorter than length of laminating rollers, and long sides each of which is longer than the length of the laminating rollers. The first sheet of optical functional film S1 is laminated on a sheet of releasing film Re1 via a pressure-sensitive adhesive layer A1 to form a sheet of optical film laminate L1′. The sheet of optical film laminate L1′ can be obtained by, for example, feeding a band of laminate in which a band of optical functional film is laminated on a band of releasing film via a pressure-sensitive adhesive layer from a roll R1 of the band of laminate, and cutting at intervals corresponding to the length of the short side of the panel member W.

The sheet of optical film laminate L1′, including the sheet of releasing film Re1 and the first sheet of optical functional film S1, is aligned such that each of the short sides extends in a direction crossing a conveying direction, and then opposing short sides of adjacent sheets of releasing film Re1 are coupled using a connecting tape T, for example. A plurality of sheets of releasing film Re1 are respectively coupled with each other to make a first band of carrier film C1. Thus, a first band of optical film laminate L1 is obtained in which each of the sheets of optical functional film S1 is continuously aligned on the first band of carrier film C1 via the pressure-sensitive adhesive layer A1.

The first band of optical film laminate L1 is conveyed toward a laminating part. At the laminating part, the sheet of optical functional film S1 is peeled with the pressure-sensitive adhesive layer A1 from the first band of carrier film C1 (that is, the film in which the adjacent short sides of the sheets of releasing film Re1 are coupled) by a peeling means. The peeled first sheet of optical functional film S1 is laminated with the TFT side surface of the panel member W by the pair of laminating rollers longer than the length of each of the short sides of the first sheet of optical functional film S1.

The second sheet of optical functional film S2 has short sides, each of which is shorter than the length of the laminating rollers, and continuously supported on a second band of carrier film C2 via a pressure-sensitive adhesive layer A2 such that each of the short sides extends in a direction crossing the conveying direction. Each of long sides of the second sheet of optical functional film S2 may be longer or shorter than the length of the laminating rollers. The second optical film laminate L2 can be obtained by, for example, feeding a band of laminate in which a band of optical functional film is laminated on the second carrier film C2 from a roll R2 of the band of laminate, and forming slit lines reaching to the pressure-sensitive adhesive layer A2 at intervals corresponding to the length of the short side of the panel member W.

The second optical film laminate L2 is conveyed toward the laminating part. At the laminating part, the second sheet of optical functional film S2 is peeled with the pressure-sensitive adhesive layer A2 from the second band of carrier film C2 by the peeling means. The peeled second sheet of optical functional film S2 is laminated with the CF side surface of the panel member W by the pair of laminating rollers.

By the way, when the size of the panel member W is smaller than a certain size, a third sheet of optical functional film S3, which each of long sides is shorter than the length of the laminating rollers, may be laminated with the TFT side surface of the panel member instead of the first sheet of optical functional film S1. In such case, it is not necessary to align the first sheet of optical functional film S1 such that each of the short sides extends in the direction crossing the conveying direction to form the first optical film laminate L1, as described in the above.

Each of the third sheet of optical functional film S3 is continuously supported on a third band of carrier film C3 via a pressure-sensitive adhesive layer A3 such that each of long sides extends in a direction crossing the conveying direction. The third optical film laminate L3 can be obtained by, for example, feeding a band of laminate in which a band of optical functional film is laminated on the third band of releasing film C3 from a roll R3 of the band of laminate, and forming slit lines reaching to the pressure-sensitive adhesive layer A3 at intervals corresponding to the length of the short side of the panel member W.

The third optical film laminate L3 is conveyed toward the laminating part. At the laminating part, the third sheet of optical functional film S3 is peeled with the pressure-sensitive adhesive layer A3 from the third band of carrier film C3 by the peeling means. The peeled third sheet of optical functional film S3 is laminated with the panel member W by the pair of laminating rollers.

### First Embodiment

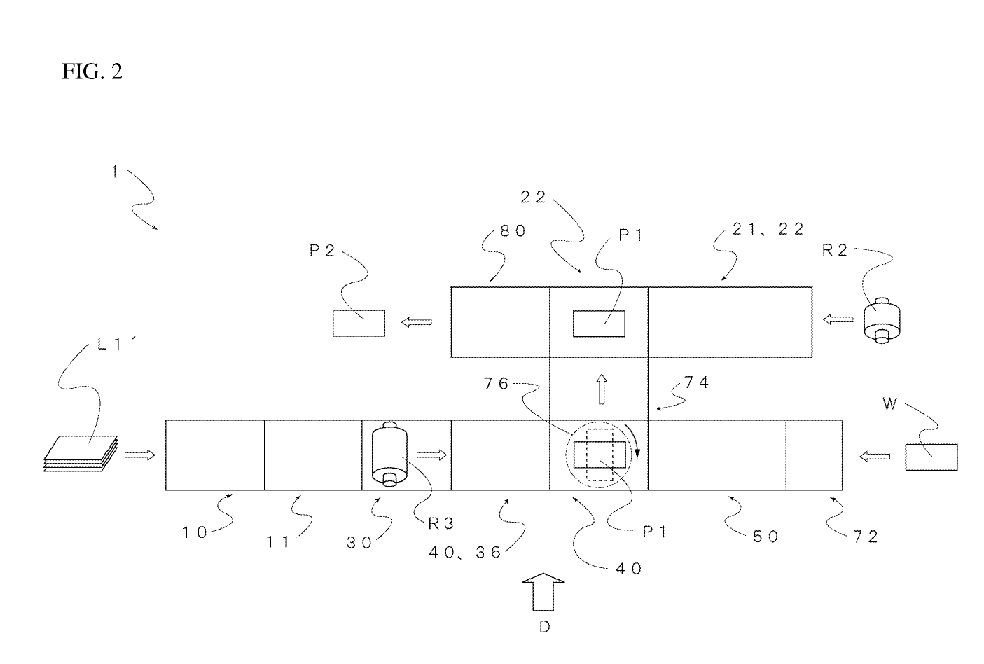

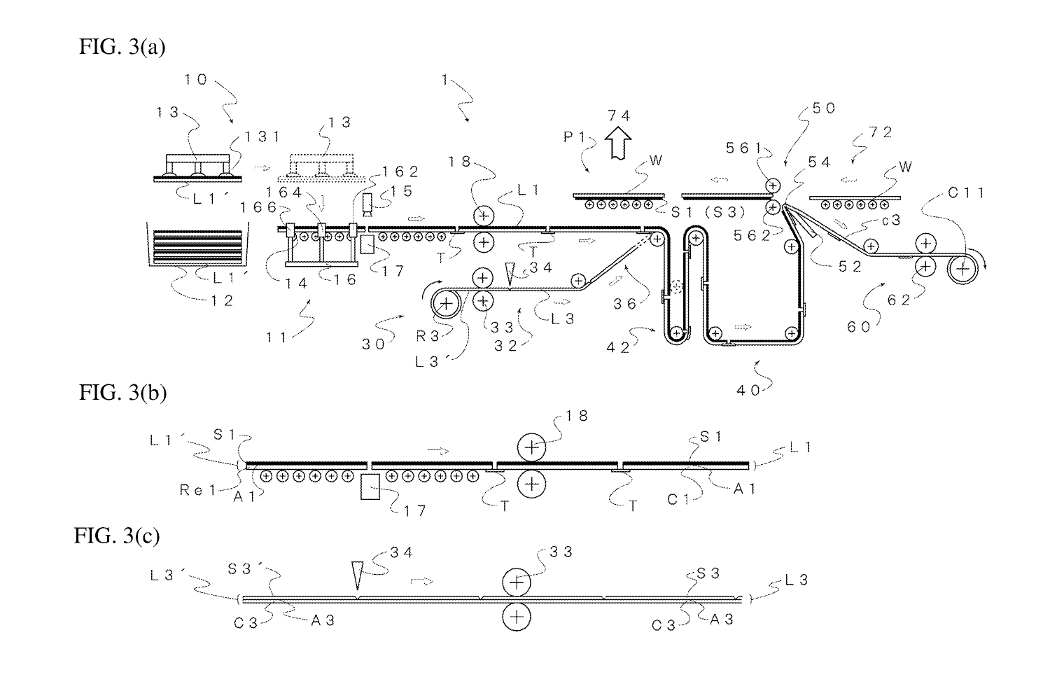

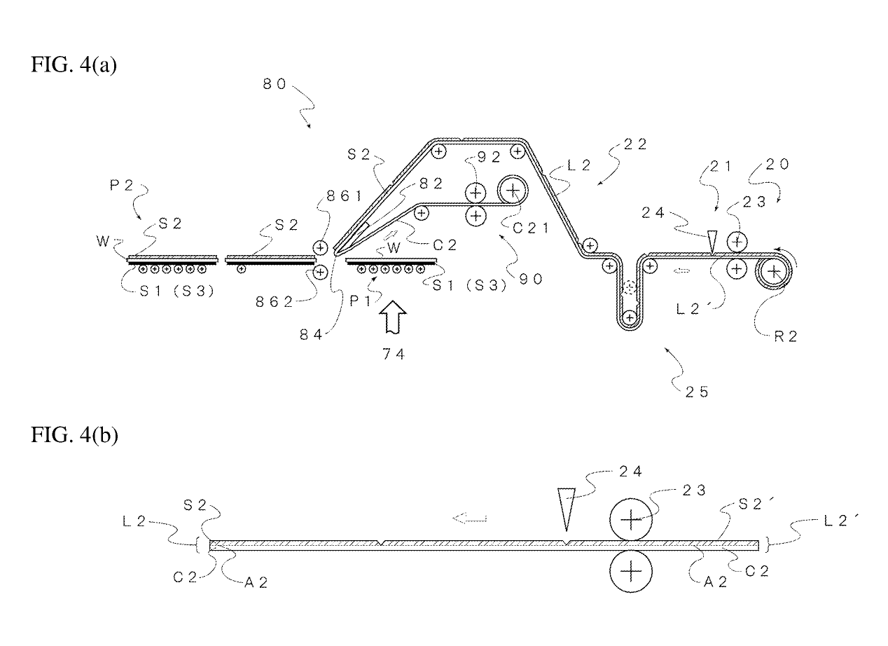

A continuous manufacturing apparatus 1 according to a first embodiment of the present invention is described in the following. FIG. 2 shows a schematic top view of the continuous manufacturing apparatus 1. FIGS. 3 and 4 respectively shows a schematic side view of the continuous manufacturing apparatus. FIG. 3(a) is a side view of a first line provided with a first laminating part 50, FIG. 4(a) is a side view of a second line provided with a second laminating part 80, and these figures are both side views seen from a direction D of FIG. 2. FIG. 3(b), FIG. 3(c) and FIG. 4(b) respectively shows a configuration of an optical film laminate.

The continuous manufacturing apparatus 1 has, as shown in FIG. 2, an optical functional film feeding part 10 for feeding the first sheet of optical functional film S1 in a form of the first optical film laminate L1′, an optical film laminate forming part 11 for forming the first optical film laminate L1, a first optical film laminate conveying part 40 for conveying the first optical film laminate L1 toward a first laminating part 50, a first panel member conveying part 72 for conveying the panel member W fed to the apparatus 1 toward the first laminating part 50, and the first laminating part 50 for laminating the first sheet of optical functional film S1 with one of opposite surfaces of the panel member W. Each of these parts 10, 11, 40, 50, and 72 is continuously arranged in a straight line.

The continuous manufacturing apparatus 1 also has a second panel member conveying part 74 for conveying an intermediate panel P1 to which the first sheet of optical functional film is laminated toward a second laminating part 80. The continuous manufacturing apparatus 1 also has a second optical film laminate conveying part 22 for conveying a second optical film laminate L2 fed from the roll R2 to the apparatus 1 toward a second laminating part 80, and the second laminating part 80 for laminating a second sheet of optical functional film S2 with the other of opposite surfaces of the intermediate panel member P1. Each of these parts 22 and 80 is continuously arranged in a straight line.

The continuous manufacturing apparatus 1 also has a third optical film laminate conveying part 36, configured as to allow for feeding a third optical film laminate L3 from the roll R3 to the apparatus 1, for conveying the fed third optical film laminate L3 toward the first laminating part 50. The third optical film laminate conveying part 36 is connected to the first optical film laminate conveying part 40. When the third optical film laminate L3 is used, at the first laminating part 50, the third sheet of optical functional film S3 (not the first sheet of optical functional film S1) is laminated with one of opposite surfaces of the panel member W. A panel member P2, formed by the first sheet of optical functional film S1 or the third sheet of optical functional 1 film S3, and the second sheet of optical functional film S2 being laminated to respective sides of the panel member W, is fed to a next process.

The optical functional film feeding part 10 feeds the first sheet of optical functional film S1 to the optical film laminate forming part 11. The first sheet of optical functional film is, as shown in FIGS. 1 and 3, fed as the sheet of optical film laminate L1′, being laminated to the sheet of releasing film Re1 via the pressure-sensitive adhesive layer A1. The optical functional film feeding part 10 includes, as shown in FIG. 3(a), an accumulating part 12 for accumulating a plurality of sheets of optical film laminate L1′ and a suctioning and conveying means 13 for taking the sheet of optical film laminate L1′ out from the accumulating part 12 one by one to covey to the optical film laminate forming part 11.

The optical functional film feeding part 10 is shown in FIG. 3(a), FIG. 3(b) and FIG. 3(c) as including the accumulating part 12 and the suctioning and conveying means 13, but not limited thereto. The optical functional film feeding part 10 may be a configuration for achieving the form shown in a middle part of FIG. 1, and for example, it may also have a configuration where, from a roll R1 of a band of laminate in which a band of optical functional film is laminated on a band of releasing film via a pressure-sensitive adhesive layer, the band of laminate is fed, cut at intervals corresponding to a length of a short side of the panel member W, and then rotated by 90 degrees.

The sheet of optical film laminate L1′ is accumulated at the accumulating part 12 such that a surface of the sheet of releasing film Re1 faces downward, and a suctioning means 131 of the suctioning and conveying means 13 suctions the first sheet of optical functional film S1 side of the sheet of optical film laminate L1′. The suctioning and conveying means 13 arranges the sheet of optical film laminate L1′ suctioned by the suctioning means 131 at a predetermined position of a conveying means 14 of the optical film laminate forming part 11 such that each of short sides extends in a direction crossing the conveying direction, and then, releases the suctioning of the suctioning means 131.

In the optical film laminate forming part 11, the first band of optical film laminate L1 can be formed from the sheet of optical film laminate L1′. The first band of optical film laminate L1 is formed by continuously aligning each of the first sheets of optical functional film S1 in the conveying direction on the first band of carrier film C1 such that each of short sides extends in a direction crossing the conveying direction. The optical film laminate forming part 11 includes, as shown in FIG. 3(a), a conveying means 14 for conveying the sheet of optical film laminate L1′, a detecting means 15 for detecting a position of the short side of the sheet of optical film laminate L1′, a position correcting means 16 for correcting positions of both long sides of the sheet of optical film laminate L1′, and a coupling means 17 for connecting the opposing short sides of adjacent sheets of optical film laminate L1′.

The sheet of optical film laminate L1′ conveyed to the optical film laminate forming part 11 by the suctioning and conveying means 13 is arranged at a predetermined position on the conveying means 14. The position correcting means 16 for correcting positions of both long sides of the sheet of optical film laminate L1′ is preferably provided at the predetermined position to allow for linearly coupling the adjacent plurality of optical film laminates L1′ with accuracy. The position correcting means 16 has holding parts 162, 164, and 166 for holding both long sides of the sheet of optical film laminate L1′ from outside, for example, and these holding parts 162 to 166 allow for aligning a lateral position of the sheet of optical film laminate L1′ with its reference position. In addition, it is preferable to read a forward short side of the sheet of optical film laminate L1′ by the detecting means 15 to align a conveying direction position with its reference position by the conveying means 14 so that a distance between the short sides of the adjacent sheets of optical film laminate L1′ is made as close as possible. The forward short side of the sheet of optical film laminate L1′ in which the lateral position and the conveying direction position are aligned with their respective reference positions may be opposed to a rearward short side of the adjacent preceding sheet of optical film laminate L1′ and a direction along the conveying direction.

The method of aligning the lateral position and the conveying direction position of the optical film laminate L1′ with their respective reference positions is not limited to the above method, and may be a method which allows for aligning with the reference positions such that adjacent optical film laminates L1′ can be coupled linearly with accuracy. In addition, a place for aligning the lateral position and the conveying direction position of the optical film laminate L1′ with their respective reference positions is not limited to the place shown in FIG. 3(a), FIG. 3(b) and FIG. 3(c). For example, a positioning mechanism may be arranged before the optical film laminate forming part 11 for once aligning the sheet of optical film laminate L1′ conveyed by the suctioning and conveying means 13 at the positioning mechanism, and then conveying the aligned sheet of optical film laminate L1′ to the optical film laminate forming part 11.

The opposing short sides of the adjacent sheets of optical film laminate L1′ are coupled by the coupling means 17. In the embodiment shown in FIG. 3(a), FIG. 3(b) and FIG. 3(c), the coupling means 17 may be a connecting tape applying means 17, but not limited thereto, and various publicly-known coupling means may be used according to necessity. The connecting tape applying means 17 is configured as, intermittently feeding a connecting tape T so that a pressure-sensitive adhesive side faces the sheet of releasing film Re1, pressing the fed connecting tape T toward the sheet of releasing film Re1 to connect the opposing short sides of adjacent two sheets of releasing film Re1, and cutting the connecting tape after connection. Such connection tape applying means 17 is generally used for connecting films, and details are described for example in Patent Literature 2 or Patent Literature 4. A plurality of sheets of releasing film Re1 connected by the connecting tape at opposing short sides become the first band of carrier film C1.

The optical film laminate forming part 11 can thus form the first band of optical film laminate L1 in which each of the first sheets of optical functional film S1 is continuously aligned on the first band of carrier film C1 via the pressure-sensitive adhesive layer A1. The formed first band of optical film laminate L1 is sent to the first optical film laminate conveying part 40 by feed rollers 18. The first optical film laminate conveying part 40 conveys the first optical film laminate L1 to the first laminating part 50 through dancer rollers 42 for adjusting a conveying speed etc.

On the other hand, the panel member to be laminated with the first sheet of optical functional film S1 is fed for example from a magazine (not shown), in which a plurality of panel members W is contained, one by one, and as shown in FIG. 3(a), conveyed by the first panel member conveying part 72 comprising a conveying means such as a roller conveyer. The panel member W is fed to the first laminating part 50 after its posture is detected and corrected (aligned) during conveyance depending on a deviation condition of the first sheet of optical functional film S1. When laminated with the first sheet of optical functional film S1, the panel member W is conveyed toward the first laminating part 50 with its short side being at the front.

At the first laminating part 50, one of opposite surfaces of the panel member W, for example, the surface of the thin film transistor (TFT side) is laminated with the first sheet of optical functional film S1. The first laminating part 50 has, as shown in FIG. 3(a), a first peeling means 52 having a tip end 54 provided to be positioned near the laminating position, and a first laminating means 56 having a first upper laminating roller 561 and a first lower laminating roller 562. At the first laminating part 50, the first sheet of optical functional film S1 and the pressure-sensitive adhesive layer A1 are peeled from the carrier film C1. The first sheet of optical functional film S1 and the pressure-sensitive adhesive layer A1 are peeled from the carrier film C1 by winding and hooking the carrier film C1 around the tip end 54 of the first peeling means 52 and folding back in a direction approximately opposite to the laminating position.

The first upper laminating roller 561 and the first lower laminating roller 562 laminate the sheet of optical functional film S1 with the panel member W by sandwiching the sheet of optical functional film S1 peeled with the pressure-sensitive adhesive layer A1 and the panel member W and applying pressure in opposing directions with each other from above and from underneath. The first upper laminating roller 561 and the first lower laminating roller 562 are provided such that respective central axes become parallel to each other. For each of the first upper laminating roller 561 and the first lower laminating roller 562, a roller formed by covering a core made of a metal and/or carbon with an elastic body such as rubber can be used, diameter thereof is about 30 mm to 80 mm, and a length in a direction parallel to the central axis is appropriately selected to correspond to a size of the optical functional film and the panel member to be laminated. When the size of the panel member W to be laminated is large, the length of each of the first upper laminating roller 561 and the first lower laminating roller 562 must be made longer depending on the size, and if the length of these laminating rollers became longer than a certain length, each of central parts may be bent downward by their own weight. Therefore, in the present invention, the respective length of the first upper laminating roller 561 and the first lower laminating roller 562 is set to be shorter than the length to be bent by their own weight, and when a sheet of optical functional film having long sides longer than the length of these laminating rollers, the sheet of optical functional film is used such that its short sides are aligned extending in a direction crossing the conveying direction.

Table 1 shows an example of experiment results of, when a sheet of optical functional film of a size corresponding to various size of panel members is laminated with each of the panel members, checking as to whether bubbles have generated between the panel member and the film depending on the length of the laminating rollers used for lamination. In this experiment, general purpose laminating rollers were used, which diameter is 50 mm, and material is nitrile butyl rubber (NBR). The sheet of optical functional film used in the experiments was a polarizing film (product serial number; SEG1423DU) of Nitto Denko Corporation. In addition, each of the panel members used in the experiments is what has been taken out from commercially available televisions by disassembling thereof, and each of the various size of the panel members is what has been included in the following liquid crystal televisions.

Panel member of 60 inches; AQUOS LC—60US30

Panel member of 65 inches; REGZA 65Z20X

Panel member of 70 inches; AQUOS LC—70XG35

Panel member of 75 inches; BRAVIA KJ—75X9400C

Panel member of 80 inches; AQUOS LC—80XL10

A gap between the upper and lower rollers is set to be 1.2 mm, and laminating speed is set to be 500 mm/s. As shown in Table 1, in the case of the laminating rollers, when the length of the laminating rollers is 1500 mm or less, bubbles by lamination were not generated. Therefore, under a condition of this experiment, it is preferable to set the length of the first upper laminating roller 561 and the first lower laminating roller 562 to be 1500 mm or less by which bubbles by lamination do not generate.

TABLE 1

| | | | Length of | Generation of |
|---|---|---|---|---|
| Panel member | Length of Short Side | | Laminating | Bubbles by |
| Size (inch) | or Long Side | | Rollers | Lamination |
| 60 | Short side | 747 mm | 850 mm | Not Generated |
| 65 | Short side | 810 mm | 900 mm | Not Generated |
| 70 | Short side | 872 mm | 950 mm | Not Generated |
| 75 | Short side | 934 mm | 1000 mm | Not Generated |
| 80 | Short side | 986 mm | 1050 mm | Not Generated |
| 60 | Long side | 1328 mm | 1400 mm | Not Generated |
| 65 | Long side | 1439 mm | 1500 mm | Not Generated |
| 70 | Long side | 1549 mm | 1600 mm | Generated |
| 75 | Long side | 1660 mm | 1750 mm | Generated |
| 80 | Long side | 1771 mm | 1850 mm | Generated |

The carrier film C1 after the first sheet of optical functional film S1 and the pressure-sensitive adhesive layer A1 are peeled off is wound by a winding means C11. The intermediate panel member P1 having the sheet of optical functional film S1 laminated with one of opposite surfaces of the panel member W (for example, the surface of the TFT side of the panel member W) is conveyed out from the first laminating part 50, and sent to a second panel member conveying part 74.

The second panel member conveying part 74 conveys, as shown in FIG. 2, the intermediate panel member P1 having the first sheet of optical functional film S1 laminated with one of opposite surfaces of the panel member W toward a second laminating part 80. In the continuous manufacturing apparatus 1 according to the present embodiment, the second panel member conveying part 74 is arranged to couple a first line where the optical functional film feeding part 10, the optical film laminate forming part 11, the first optical film laminate conveying part 40, the first panel member conveying part 72, and the first laminating part 50 are aligned, and a second line where a second optical film laminate conveying part 22 and a second laminating part 80, described later, are aligned.

The continuous manufacturing apparatus 1 further includes, as shown in FIG. 4(a), a feeding part 20 for feeding an optical film laminate L2′ from a roll of laminate R2, a slit line forming part 21 having a slit line forming means 24 for forming slit lines on the optical film laminate L2′, and a second optical film laminate conveying part 22 for conveying the second optical film laminate L2 on which slit lines are formed. The second optical film laminate L2 is conveyed to the second laminating part 80 by the second optical film laminate conveying part 22.

The optical film laminate L2′ is, as shown in FIG. 4(b), a laminate in which a second band of optical functional film S2′ is laminated on a second band of carrier film C2 via a second pressure-sensitive adhesive layer A2. The second optical film laminate L2 is the laminate in which slit lines reaching to the pressure-sensitive adhesive layer A2 from a second band of optical functional film S2′ side are formed on the fed optical film laminate L2′. When a laminate in which slit lines are preliminarily formed, that is, the second optical film laminate L2, is used as the optical film laminate L2′ fed from the feeding part 20, the roll R2 is a roll of the second optical film laminate L2, and thus, the slit line forming part 21 is unnecessary.

At the second laminating part 80, the second sheet of optical functional film S2 is laminated with the other of opposite surfaces, for example, the surface of the color filter side (CF side), of the intermediate panel member P1 formed by laminating the first optical functional film S1 with one of opposite surfaces of the panel member W. The second laminating part 80 has, as shown in FIG. 4(a), a second peeling means 82 having a tip end 84 provided to be positioned near the laminating position, and second laminating means 86 having a second upper laminating roller 861 and a second lower laminating roller 862. At the second laminating part 80, the second sheet of optical functional film S2 and the pressure-sensitive adhesive layer A2 are peeled from the carrier film C2. The second sheet of optical functional film S2 and the pressure-sensitive adhesive layer A2 are peeled from the carrier film C2 by winding and hooking the carrier film C2 around the tip end 84 of the second peeling means 82 and folding back in a direction approximately opposite to the laminating position.

The second upper laminating roller 861 and the second lower laminating roller 862 laminate the second sheet of optical functional film S2 with the intermediate panel member P1 by sandwiching the sheet of optical functional film S2 peeled with the pressure-sensitive adhesive layer A2 and the intermediate panel member P1, and applying pressure in opposing directions with each other from above and from underneath. The second upper laminating roller 861 and the second lower laminating roller 862 are provided such that respective central axes become parallel to each other. For each of the second upper laminating roller 861 and the second lower laminating roller 862, a roller formed by covering a core made of a metal and/or carbon with an elastic body such as rubber can be used, diameter thereof is about 30 mm to 80 mm, and a length in a direction parallel to the central axis is appropriately selected to correspond to a size of the optical functional film and the panel member to be laminated. When the size of the panel member W to be laminated is large, the length of each of the second upper laminating roller 861 and the second lower laminating roller 862 must be made longer depending on the size. However, different from the first laminating means 56, since the length of each of the second upper laminating roller 861 and the second lower laminating roller 862 can be made as corresponding to the short side of the second sheet of optical functional film S2, it is possible to set it shorter than a length which may be bent by their own weight. For example, in the above Table 1, even in a case of the panel member having 80 inches, the length of the laminating roller corresponding to the short side is 1050 mm, and this is shorter than the length of the laminating roller, which is 1500 mm, where bubbles by lamination were not generated.

In the continuous manufacturing apparatus 1, when a panel member W smaller than a certain size is used, a third sheet of optical functional film S3 which length of each of long sides is shorter than the length of the first laminating rollers 56, not the first sheet of optical functional film S1 which length of each of the long sides is longer than the length of the first laminating rollers 56 may be laminated with the face of the TFT side of the panel member W. In this case, it is not necessary to form the first optical film laminate L1 by aligning each of the short sides of the first sheet of optical functional film S1 in the direction extending across the conveying direction as described in the above, and the optical film laminate L3 having a width corresponding to the length of the long side of the panel member W can be used. For this purpose, the continuous manufacturing apparatus 1 further includes, as shown in FIG. 3(a), a feeding part 30 for feeding an optical film laminate L3′ from the roll R3 of laminate, a slit line forming part 32 having a slit line forming means 34 for forming slit lines in the optical film laminate L3′, and the third optical film laminate conveying part 36 for conveying the third optical film laminate L3 on which slit lines are formed.

The third optical film laminate L3 can be formed from the optical film laminate L3′. The optical film laminate L3′ is, as shown in FIG. 3(c), a laminate in which a third band of optical functional film S3′ is laminated on a third band of carrier film C3 via a third pressure-sensitive adhesive layer A3. The third optical film laminate L3 is the laminate in which slit lines reaching to the pressure-sensitive adhesive layer A3 from a third band of optical functional film S3′ side are formed on the optical film laminate L3′ fed from the roll R3. When a laminate in which slit lines are preliminarily formed, that is, the third optical film laminate L3, is used as the optical film laminate L3′ fed from the roll R3, the roll R3 is a roll of the third optical film laminate L3, and thus, the slit line forming part 32 is unnecessary.

The third optical film laminate conveying part 36 is connected so that the third optical film laminate L3 may be passed to the first optical film laminate conveying part 40 at any position of the first optical film laminate conveying part 40. Therefore, the third optical film laminate L3 can be conveyed on a path the same as the path on which the first optical film laminate L1 is conveyed toward the first laminating part 50.

When laminated with the third sheet of optical functional film S3, the panel member W is conveyed toward the first laminating part 50 with its long side being at the front at the first panel member conveying part 72, and laminated with the third sheet of optical functional film S3 at the first laminating part 50 from the forward long side toward the rearward long side in the conveying direction. On the other hand, when laminated with the first sheet of optical functional film S1, the panel member W is conveyed toward the first laminating part 50 with the short side being at the front at the first panel member conveying part 72, and laminated from the forward short side toward the rearward short side in the conveying direction at the first laminating part 50. Thus, an orientation of the panel member W when sent to the first laminating part 50 is different depending on whether the first sheet of optical functional film S1 is used or the third sheet of optical functional film S3 is used. Therefore, the panel member W needs to be fed with its short side at the front or its long side at the front according to necessity when fed to the first panel member conveying part 72. Alternatively, the first panel member conveying part 72 may be provided with a rotating part for rotating the panel member W by 90 degrees around an axis perpendicular to its main surface.

In addition, the intermediate panel member P1, when the first optical functional film S1 is laminated with one of opposite surfaces of the panel member W, can be conveyed by the second panel member conveying part 74 with the orientation as it is, that is, the orientation shown by a solid line in FIG. 2. On the other hand, the intermediate panel member P1, when the third sheet of optical functional film S3 is laminated with one of opposite surfaces of the panel member W, has an orientation shown by a dotted line in FIG. 2 when the lamination is finished. Therefore, the second panel member conveying part 74 is preferably provided with a rotating part 76 for rotating the intermediate panel member P1 by 90 degrees around an axis perpendicular to its main surface to allow for making the intermediate panel member P1 having the orientation shown by the dotted line in FIG. 2 to have the orientation shown by the solid line.

### Second Embodiment

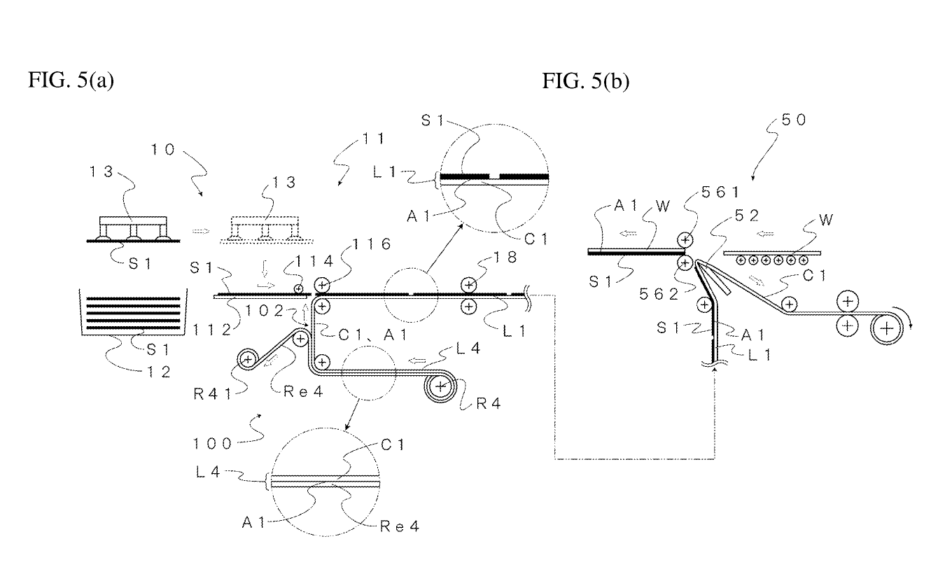

Next, a continuous manufacturing apparatus 1 according to a second embodiment of the present invention is described. FIG. 5(a) and FIG. 5(b) show a schematic side view of a part of the continuous manufacturing apparatus 1, and it is a part of a first line provided with the first laminating part 50. FIG. 5(a) shows the optical functional film feeding part 10, the optical film laminate forming part 11, and the carrier film feeding part 100, and FIG. 5(b) shows the first laminating part 50. Further, configurations which are not referred in the following descriptions, and configurations which are not shown in FIG. 5(a) and FIG. 5(b) are the same as those in FIGS. 2 to 4.

As shown in FIG. 5(a) and FIG. 5(b), in this embodiment, only the first sheets of optical functional film S1 are accumulated in the accumulating part 12 of the optical functional film feeding part 10. The first sheet of optical functional film S1 taken out from the accumulating part 12 one by one can be conveyed to the optical film laminate forming part 11 by the suctioning and conveying means 13.

The optical film laminate forming part 11 has a sheet of optical functional film feeding base 112, a feed roller 114 of the sheet of optical functional film, and laminating rollers 116 for laminating the first sheet of optical functional film S1 and the first band of carrier film C1. The first sheet of optical functional film S1 conveyed by the suctioning and conveying means 13 is arranged at a predetermined position of the sheet of optical functional film feeding base 112 such that each of the short side extends in a direction crossing the conveying direction. Although not shown in FIG. 5(a) and FIG. 5(b), it is preferable to provide the position correcting means 16 for aligning the lateral position of the first sheet of optical functional film S1 with the reference position, and the detecting means 15 for detecting the conveying direction position, at predetermined positions as in FIG. 3(a), FIG. 3(b) and FIG. 3(c). The first sheet of optical functional film S1, preferably, has its lateral position and the conveying direction position aligned with their respective reference positions, and then sent to a position to be laminated with the first band of carrier film C1 by the feed rollers 114.

In this embodiment, the continuous manufacturing apparatus 1 includes the carrier film feeding part 100 for feeding the first band of carrier film C1 to the optical film laminate forming part 11. At the carrier film feeding part 100, a band of film laminate L4 including the first band of carrier film C1 is fed from a roll R4. The band of film laminate L4 has, as shown in FIG. 5(a) and FIG. 5(b), a structure in which the first band of carrier film C1 is laminated on a band of releasing film Re 4 via the first pressure-sensitive adhesive layer A1. The first pressure-sensitive adhesive layer A1 may be used for laminating the first sheet of optical functional film S1 with the panel member W. The carrier film feeding part 100 has a peeling part 102, and at the peeling part 102, the band of releasing film Re 4 is peeled from the band of film laminate L4. The first band of carrier film C1 with the first pressure-sensitive adhesive layer A1 after the band of releasing film Re 4 is peeled off is fed to the optical film laminate forming part 11.

At the optical film laminate forming part 11, the first band of carrier fil C1 with the first pressure-sensitive adhesive layer A1 fed from the carrier film feeding part 100 is laminated with the first sheet of optical functional film S1 sent from the sheet of optical functional film feeding base 112, by the laminating rollers 116. The optical film forming part 11 can thus form the first band of optical film laminate L1 in which each of the first sheets of optical functional film S1 is continuously aligned on the first band of carrier film C1 via the pressure-sensitive adhesive layer A1. The formed fist band of optical film laminate L1 is sent to the first optical film laminate conveying part 40 by the feed rollers 18.

At the first laminating part 50, as shown in FIG. 5(b), the first sheet of optical functional film S1 with the first pressure-sensitive adhesive layer A1 is peeled from the first band of carrier film C1, and the first sheet of optical functional film S1 is laminated with one of opposite surfaces of the panel member via the pressure-sensitive adhesive layer A1.

### Third Embodiment

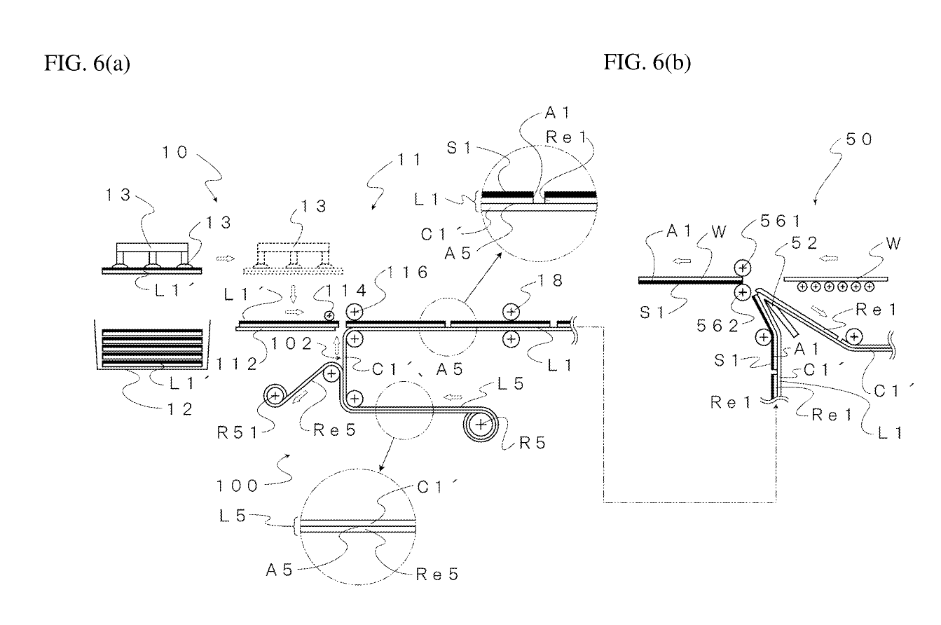

Next, a continuous manufacturing apparatus 1 according to a third embodiment of the present invention is described. FIG. 6(a) and FIG. 6(b) show schematic side view of a part of the continuous manufacturing apparatus 1, and it is a part of a first line provided with the first laminating part 50. FIG. 6(a) shows the optical functional film feeding part 10, the optical film laminate forming part 11, and the carrier film feeding part 100, and FIG. 6(b) shows the first laminating part 50. Further, configurations which are not referred in the following description and configurations which are not shown in FIG. 6(a) and FIG. 6(b) are the same as those in FIGS. 2 to 4.

A configuration of the apparatus according to this embodiment is the same as the second embodiment shown in FIG. 5(a) and FIG. 5(b), but it is different therefrom in that the first sheet of optical functional film S1 is conveyed to the optical film laminate forming part 11 as the sheet of optical film laminate L1′. The sheet of optical film laminate L1′ is, as shown in FIG. 3(a), FIG. 3(b) and FIG. 3(c), the laminate in which the first sheet of optical functional film S1 is laminated on the sheet of releasing film Re1 via the pressure-sensitive adhesive layer A1. The sheet of optical film laminate L1′ is conveyed to the optical film laminate forming part 11 by the suctioning and conveying means 13, and arranged on the sheet of optical functional film feeding base 112 such that each of the short sides extends in the direction crossing the conveying direction and that the sheet of releasing film Re1 faces downward.

At the carrier film feeding part 100, a band of film laminate L5 including a band of carrier film C1′is fed from a roll R5. The band of film laminate L5 has, as shown in FIG. 6(a) and FIG. 6(b), a structure in which the band of carrier film C1′ is laminated on a band of releasing film Re 5 via a pressure-sensitive adhesive layer A5. At the peeling part 102 of the carrier film feeding part 100, the band of releasing film Re 5 is peeled from the band of film laminate L5. The band of carrier film C1′ with the pressure-sensitive adhesive layer A5 after the band of releasing film Re 5 is peeled off is fed to the optical film laminate forming part 11.

The sheet of optical film laminate L1′ conveyed to the optical film laminate forming part 11 and sent from the sheet of optical functional film feeding base 112 by the feed rollers 114, and the band of carrier film C1′ with the pressure-sensitive adhesive layer A5 fed from the carrier film feeding part 100 are laminated by the laminating rollers 116. At this point, the sheet of optical film laminate L1′ is laminated such that the sheet of releasing film Re1 contacts the pressure-sensitive adhesive layer A5.

The optical film laminate laminated by the laminating rollers 116 is made by laminating the band of carrier film C1′, the pressure sensitive adhesive layer A5, the sheet of releasing film Re1, the first pressure-sensitive adhesive layer A1, and the first sheet of optical functional film S1 in this order. The band of carrier film C1′, the pressure-sensitive adhesive layer A5, and the sheet of releasing film Re1 in this laminate function as a band of carrier film as a whole, and thus, this laminate can be considered as equivalent to the first optical film laminate L1. The formed first band of optical film laminate L1 is fed to the first optical film laminate conveying part 40 by the feed rollers 18.

At the first laminating part 50, as shown in FIG. 6(a), the first sheet of optical functional film S1 and the pressure-sensitive adhesive layer A1 are peeled from the first optical film laminate L1, and the first sheet of optical functional film S1 is laminated with one of opposite surfaces of the panel member via the pressure-sensitive adhesive layer A1. The rest of the laminate after the first sheet of optical functional film S1 and the pressure-sensitive adhesive layer A1 are peeled off, that is, the band of carrier film C1′, the pressure-sensitive adhesive layer A5, and the sheet of releasing film Re1 are wound by a winding roll C11.

### Fourth Embodiment

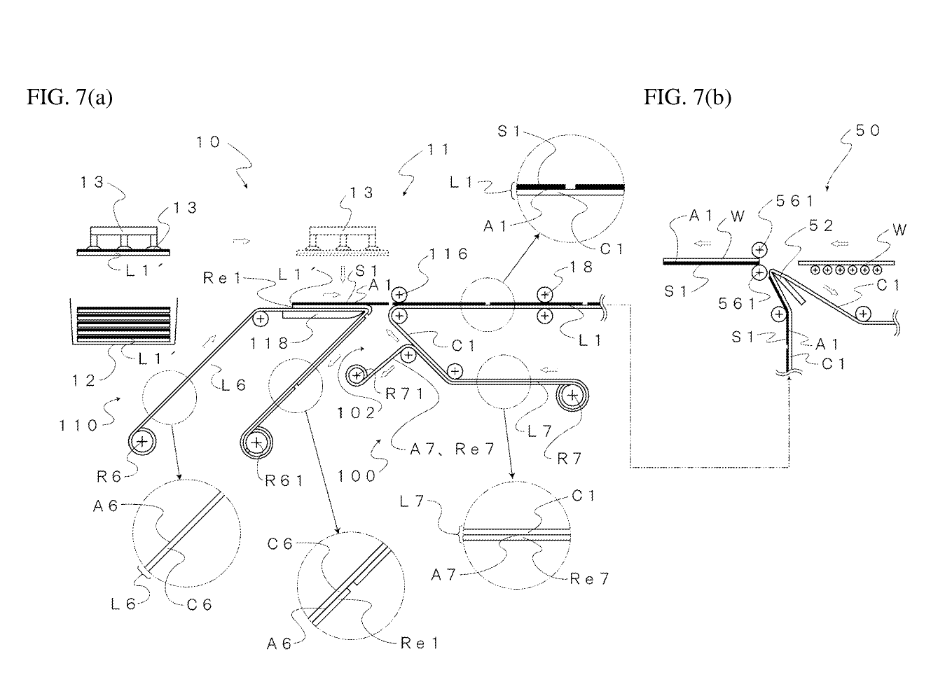

Next, a continuous manufacturing apparatus 1 according to a fourth embodiment of the present invention is described. FIG. 7(a) and FIG. 7(b) show a schematic side views of a part of the continuous manufacturing apparatus 1, and it is a part of a first line provided with the first laminating part 50. FIG. 7(a) shows the optical functional film feeding part 10, the optical film laminate forming part 11, the carrier film feeding part 100, and a film feeding part for peeling releasing film 110, and FIG. 7(b) shows the first laminating part 50. Further, configurations which are not referred in the following description and configurations which are not shown in FIG. 7(a) and FIG. 7(b) are the same as those in FIGS. 2 to 4.

As shown in FIG. 7(a) and FIG. 7(b), in this embodiment, the first sheet of optical functional film S1 is conveyed to the optical film laminate forming part 11 as the sheet of optical film laminate L1′. The sheet of optical film laminate L1′ is, as shown in FIG. 3(a), FIG. 3(b) and FIG. 3(c), a laminate in which the first sheet of optical functional film S1 is laminated on the sheet of releasing film Re1 via the pressure-sensitive adhesive layer A1. The sheet of optical film laminate L1′ is conveyed to the optical film laminate forming part 11 by the suctioning and conveying means 13.

In this embodiment, the optical film laminate forming part 11 has a sheet of releasing film peeling means 118, and laminating rollers 116 for the first sheet of optical functional film S1 and the first band of carrier film C1. In addition, the continuous manufacturing apparatus 1 further has the film feeding part for peeling releasing film 110. The film feeding part for peeling releasing film 110 feeds a film for peeling releasing film L6 to the optical film laminate forming part 11. The film for peeling releasing film L6 is, as shown in FIG. 7(a) and FIG. 7(b), a film in which a pressure sensitive adhesive layer A6 is laminated on a band of film C6, and is fed to the sheet of releasing film peeling means 118.

At the optical film laminate forming part 11, the sheet of optical film laminate L1′ may be laminated on the pressure-sensitive adhesive layer A6 of the film for peeling releasing film L6 fed to the sheet of releasing film peeling means 118 such that the sheet of releasing film Re1 contacts the pressure-sensitive adhesive layer A6. The film for peeling releasing film L6, to which the sheet of optical film laminate L1′ is laminated, is wound and hooked around a tip end of the sheet of releasing film peeling means 118 to be conveyed, and thus, the sheet of releasing film Re1 can be peeled from the sheet of optical film laminate L1′.

The rest of the sheet of optical film laminate L1′ after the sheet of releasing film Re1 is peeled off, that is, the first sheet of optical functional film S1 with the first pressure-sensitive adhesive layer A1 is fed to the laminating rollers 116. On the other hand, the film for peeling releasing film L6 to which the sheet of releasing film Re1 is laminated is wound to R61.

The continuous manufacturing apparatus 1 has, similar to the second embodiment shown in FIG. 5(a) and FIG. 5(b), the carrier film feeding part 100 for feeding the first band of carrier film C1 to the optical film laminate forming part 11. At the carrier film feeding part 100, a band of film laminate L7 including the first band of carrier film C1 is fed from a roll R7. The band of film laminate L7 has, as shown in FIG. 7(a) and FIG. 7(b), a structure in which the first band of carrier film C1 is laminated on a band of releasing film Re 7 via a pressure-sensitive adhesive layer A7.

The carrier film feeding part 100 has the peeling part 102, and at the peeling part 102, the band of releasing film Re7 is peeled with the pressure-sensitive adhesive layer A7 from the band of film laminate L7. The band of carrier film C1 after the band of releasing film Re7 is peeled off is fed to the optical film laminate forming part 11.

At the optical film laminate forming part 11, the first band of carrier film C1 fed from the carrier film feeding part 100 can be laminated to the first sheet of optical functional film S1 with the first pressure-sensitive adhesive layer A1 sent from the sheet of releasing film peeling means 118, by the laminating rollers 116. The optical film laminate forming part 11 can thus form the first band of optical film laminate L1 in which each of the first sheets of optical functional film S1 is continuously aligned on the first band of carrier film C1 via the first pressure-sensitive adhesive layer A1. The formed first band of optical film laminate L1 is fed to the first optical film laminate conveying part 40 by the feed rollers 18.

At the first laminating pat 50, as shown in FIG. 7(b), the first sheet of optical functional film S1 and the pressure-sensitive adhesive layer A1 are peeled from the carrier film C1, and the first sheet of optical functional film S1 is laminated with one of opposite surfaces of the panel member via the pressure-sensitive adhesive layer A1.

### REFERENCE SIGNS LIST

1: Continuous manufacturing apparatus
10: Optical functional film feeding part

12: Accumulating part

13: Suctioning and conveying means
11: Optical film laminate forming part

14: Conveying means

15: Detecting means

16: Position correcting means

17: Connecting tape applying means (Coupling means)

112: Sheet of optical functional film feeding base

114: Feed rollers

116: Laminating rollers
118: Sheet of releasing film Re 1 peeling means
100: Carrier film feeding part

102: Peeling part

110: Film feeding part for peeling releasing film
20: Second optical film laminate feeding part
21: Second slit line forming part

24: Slit line forming means
22: Second optical film laminate conveying part
30: Third optical film laminate feeding part
32: Third slit line forming part

34: Slit line forming means
36: Third optical film laminate conveying part
40: First optical film laminate feeding part
50: First laminating part
60: First carrier film winding part
72, 74: Panel member conveying part
80: Second laminating part
90: Second carrier film winding part
L1: First band of optical film laminate

S1: First sheet of optical functional film

A1: First pressure-sensitive adhesive layer

C1: First band of carrier film
L1′: Sheet of optical film laminate

Re1: Sheet of releasing film
L2: Second band of optical functional film

S2: Second sheet of optical functional film

A2: Second pressure-sensitive adhesive layer

C2: Second band of carrier film
L2′: Second band of optical film laminate before forming slit lines
L3: Third band of optical film laminate

S3: Third sheet of optical functional film

A3: Third pressure-sensitive adhesive layer

C3: Third band of carrier film
L3′: Third band of optical film laminate before forming slit lines
L4: Band of film laminate

Re4: Band of releasing film
L5: Band of film laminate

C1′: Band of carrier film

Re5: Band of releasing film
L6: Film for peeling releasing film

A6: Pressure-sensitive adhesive layer

C6: Band of film
L7: Band of film laminate

Re7: Band of releasing film
R1: First roll of laminate
R2: Second roll of laminate
R3: Third roll of laminate
T: Connecting tape
W: Panel member
P1: Intermediate laminate
P2: Optical display unit

1. A continuous manufacturing apparatus for an optical display unit comprising
an optical functional film feeding part for feeding rectangular first sheets of optical functional film,
an optical film laminate forming part for forming a first band of optical film laminate in which each of the first sheets of optical functional film is continuously aligned in a conveying direction such that each of short sides extends in a direction crossing the conveying direction on a first band of carrier film,
a first optical film laminate conveying part for conveying the first band of optical film laminate toward a first laminating part,
a second optical film laminate conveying part for conveying a second band of optical film laminate including a second band of carrier film and rectangular second sheets of optical functional film continuously supported on the second band of carrier film such that each of short sides extends in a direction crossing the conveying direction toward a second laminating part,
a panel member conveying part for conveying a panel member toward the first and second laminating parts,
the first laminating part including a first peeling means for peeling the first sheet of optical functional film from the first band of carrier film, and a first laminating means, which is longer than the short side of the first sheet of optical functional film, for laminating the peeled first sheet of optical functional film with one of opposite surfaces of the panel member, and
the second laminating part including a second peeling means for peeling the second sheet of optical functional film from the second band of carrier film, and a second laminating means for laminating the peeled second sheet of optical functional film with the other of opposite surfaces of the panel member.

2. A continuous manufacturing apparatus for the optical display unit according to claim 1, wherein each of the first sheets of optical functional film fed from the optical functional film feeding part is laminated on each of sheets of releasing film, and
the optical film laminate forming part includes a coupling means for coupling opposing short sides of the sheets of releasing film to make the first band of carrier film.

3. A continuous manufacturing apparatus for the optical display unit according to claim 1, further comprising a carrier film feeding part for feeding the first band of carrier film, and
the optical film laminate forming part is configured to laminate the first sheet of optical functional film fed from the optical functional film feeding part on the first band of carrier film fed from the carrier film feeding part.

4. A continuous manufacturing apparatus for the optical display unit according to claim 3, wherein each of the first sheets of optical functional film fed from the optical functional film feeding part is laminated on each of sheets of releasing film, and
the optical film laminate forming part is configured to laminate the first sheet of optical functional film with the sheet of releasing film fed from the optical functional film feeding part on the first band of carrier film fed from the carrier film feeding part such that the sheet of releasing film contacts the first band of carrier film.

5. A continuous manufacturing apparatus for the optical display unit according to claim 3, wherein each of the first sheets of optical functional film fed from the optical functional film feeding part is laminated on each of sheets of releasing film, and
the optical film laminate forming part includes a peeling means for peeling the sheet of releasing film from the first sheet of optical functional film with the sheet of releasing film fed from the optical functional film feeding part, and configured to laminate the first sheet of optical functional film after the sheet of releasing film is peeled on the first band of carrier film fed from the carrier film feeding part.

6. A continuous manufacturing apparatus for the optical display unit according to claim 1, further comprising a third optical film laminate conveying part for conveying a third band of optical film laminate including a third band of carrier film and rectangular third sheets of optical functional film continuously supported on the third band of carrier film toward the first laminating part such that each of long sides shorter than the length of the first laminating means extends in a direction crossing the conveying direction.

7. A continuous manufacturing apparatus for the optical display unit according to claim 6, further comprising a rotating part for rotating an intermediate laminate in which the third sheet of optical functional film is laminated with one of opposite surfaces of the panel member, or an intermediate laminate before the third sheet of optical functional film is laminated with one of opposite surfaces of the panel member, by 90 degrees.

8. A continuous manufacturing method for an optical display unit comprising steps of
feeding a rectangular first sheet of optical functional film,
forming a first band of optical film laminate in which each of the first sheets of optical functional films is continuously aligned in a conveying direction such that each of short sides extends in a direction crossing the conveying direction on a first band of carrier film,
conveying the first band of optical film laminate toward a first laminating position,
conveying a second band of optical film laminate including a second band of carrier film and each of rectangular second sheets of optical functional film continuously supported on the second band of carrier film such that each of short sides extends in a direction crossing the conveying direction toward a second laminating position,
conveying a panel member toward the first and second laminating positions,
peeling the first sheet of optical functional film from the first band of carrier film, and laminating the peeled first sheet of optical functional film with one of opposite surfaces of the panel member using a first laminating means which is longer than the short side of the first sheet of optical functional film, and
peeling the second sheet of optical functional film from the second band of carrier film, and laminating the peeled second sheet of optical functional film with the other of opposite surfaces of the panel member using a second laminating means.

9. A continuous manufacturing method for an optical display unit according to claim 8, wherein each of the first sheets of optical functional film fed in the step of feeding the first sheet of optical functional film is laminated on each of sheets of releasing film, and
the step of forming the first band of optical film laminate includes a step of coupling opposing short sides of the sheets of releasing film to make the first band of carrier film.

10. A continuous manufacturing method for the optical display unit according to claim 8, further comprising a step of feeding the first band of carrier film, and
the step of forming the first band of optical film laminate includes a step of laminating the first sheet of optical functional film fed in the step of feeding the first sheet of optical functional film on the first band of carrier film fed in the step of feeding the first band of carrier film.

11. A continuous manufacturing method for the optical display unit according to claim 10, wherein each of the first sheets of optical functional film fed in the step of feeding the first sheet of optical functional film is laminated on each of sheets of releasing film, and
the step of forming the first band of optical film laminate includes a step of laminating the first sheet of optical functional film with the sheet of releasing film fed in the step of feeding the first sheet of optical functional film on the first band of carrier film fed in the step of feeding the band carrier film such that the sheet of releasing film contacts the first band of carrier film.

12. A continuous manufacturing method for the optical display unit continuous manufacturing method according to claim 10, wherein each of the first sheets of optical functional film fed in the step of feeding the first sheet of optical functional film feeding part is laminated on each of sheets of releasing film, and
the step of forming the first band of optical film laminate includes a step of peeling the sheet of releasing film from the first sheet of optical functional film with the sheet of releasing film fed in the step of feeding the first sheet of optical functional film, and a step of laminating the first sheet of optical functional film after the sheet of releasing film is peeled on the first band of carrier film fed in the step of feeding the first band of carrier film.

13. A continuous manufacturing apparatus for the optical display unit according to claim 2, further comprising a third optical film laminate conveying part for conveying a third band of optical film laminate including a third band of carrier film and rectangular third sheets of optical functional film continuously supported on the third band of carrier film toward the first laminating part such that each of long sides shorter than the length of the first laminating means extends in a direction crossing the conveying direction.

14. A continuous manufacturing apparatus for the optical display unit according to claim 3, further comprising a third optical film laminate conveying part for conveying a third band of optical film laminate including a third band of carrier film and rectangular third sheets of optical functional film continuously supported on the third band of carrier film toward the first laminating part such that each of long sides shorter than the length of the first laminating means extends in a direction crossing the conveying direction.

15. A continuous manufacturing apparatus for the optical display unit according to claim 4, further comprising a third optical film laminate conveying part for conveying a third band of optical film laminate including a third band of carrier film and rectangular third sheets of optical functional film continuously supported on the third band of carrier film toward the first laminating part such that each of long sides shorter than the length of the first laminating means extends in a direction crossing the conveying direction.

16. A continuous manufacturing apparatus for the optical display unit according to claim 5, further comprising a third optical film laminate conveying part for conveying a third band of optical film laminate including a third band of carrier film and rectangular third sheets of optical functional film continuously supported on the third band of carrier film toward the first laminating part such that each of long sides shorter than the length of the first laminating means extends in a direction crossing the conveying direction.
